(19) United States
(12) Patent Application Publication
(10) Pub. No.: US 2016/0077981 A1
(43) Pub. Date: Mar. 17, 2016

(54) Method and Apparatus for Efficient User-Level IO in a Virtualized System

(71) Applicant: Advanced Micro Devices, Inc., Sunnyvale, CA (US)

(72) Inventor: Andrew G. KEGEL, Redmond, WA (US)

(21) Appl. No.: 14/484,944

(22) Filed: Sep. 12, 2014

(51) Int. Cl. G06F 13/10; G06F 9/455

(52) U.S. Cl. CPC G06F 13/102; G06F 9/45533

(57) ABSTRACT

In a virtualized computer system without an IOMMU, all application IO requests must be processed by the guest operating system and by the hypervisor so that addresses are translated (twice) and validated (twice) properly. In a virtualized computer system with an IOMMU containing one “stage” of translation, the peripheral can safely be assigned directly to a guest OS because the IOMMU can be programmed to translate and check addresses issued by the device. As a result, route IO overhead due to hypervisor intervention can be eliminated. In one example, in a virtualized computer system with an IOMMU supporting two “stages” of translation, the peripheral can safely be assigned directly to an application within a guest OS. As a result, route IO overhead due to hypervisor and guest OS processing can be eliminated. This allows an application to achieve higher IO performance.

### BACKGROUND

1. Field

The disclosed embodiments relate generally to computer systems, and in particular to memory management units for input/output (IO) devices.

2. Background Art

Computer systems of various types are ubiquitous in modern society, including personal computers (PCs), workstations, servers, various personal digital assistant (PDA) devices, etc. Most, if not all, of these computer systems have implemented memory management functionality for processor accesses to memory. Generally, the memory management functionality has included translating addresses from a virtual address space used by each process to a physical address space that spans the actual system memory, along with various memory protections (e.g., read only, read/write, privilege level requirements, etc.). The memory management functionality has a variety of uses, such as protecting the memory used by each process from unauthorized access by other processes, permitting large virtual spaces to be used by processes even if the physical memory system is not that large, relocation of virtual addresses to available physical memory without the participation of the process, and the like.

Like processor addresses that are frequently translated, addresses used by input/output (IO) devices in computer systems can also be translated. That is, the IO devices can use virtual addresses rather than physical addresses to access memory. Use of virtual addresses rather than physical addresses by devices is preferred in current day systems since it improves the overall security of the system. Use of physical addresses by a rogue device (or a device programmed by a malicious software agent) would result in impeded memory access.

In single operating system (OS) computer systems, such as most PCs, the OS controls access to the IO devices by other processes (applications and OS services). Accordingly, the OS can control which process has access to a given device at any given point in time, and can at least somewhat control the addresses accessed by the device. Virtual machine systems are more complex, as they may have multiple guest OSs running on a virtual machine monitor. In a virtualized system, many applications and IO devices access physical memory through the use of virtual addresses. An IO memory unit is coupled to the IO devices and the system memory, where the IOMMU is configured to translate the virtual address in the device memory request to physical addresses to access the physical system memory.

Modern day computing environments include virtual machine (VM) environments, in which multiple VMs can execute on a single processor system as separate logical operating entities. Typically, these logically separated VMs share common resources of the processor system, such as hardware devices and device drivers. To manage the co-existence of these multiple VMs and to enable exchanging information with common resources and between these VMs, VM environments often use a virtual machine monitor (VMM) or hypervisor.

Security and stability are important issues in most computer systems, and in particular to VM environments. In traditional computer systems, peripheral devices and their associated device drivers have free and unfettered access to memory. Such unfettered access means that a corrupted or malfunctioning device or device driver can write in any location in memory, whether or not that memory location has been set aside for use by that peripheral. Should a memory location set aside for operating system use be overwritten by the malfunctioning device, a system crash will almost inevitably result. Computer system users demand stability, and system crashes due to memory corruption are sought to be minimized.

As can be expected, the attention directed to stability and security aspects requires the use of CPU cycles to provide the additional functionality. Such CPU cycle usage constitutes overhead in the sense that it does not directly contribute to the functionality of the application. Consequently, the additional overhead results in a reduction in efficiency to that achievable without the additional security and stability.

### BRIEF SUMMARY OF THE EMBODIMENTS

What is needed is a virtual IOMMU that can prevent any improper access in a virtualization environment while offering an improved efficiency over that provided by a normal IOMMU.

In some embodiments, a user-level IO function is described in a virtualized environment. The user-level IO function receives an IO operation from a device driver associated with an IO device. The IO operation has one or more guest virtual addresses. An IO memory management unit (IOMMU) validates the one or more guest virtual addresses as being associated with the IO card. If the one or more guest virtual addresses are associated with the IO card, the IO operation is allowed to propagate to the IO card.

In some embodiments, a method is described for propagating an IO operation from a device driver across to an IO card in a virtualized environment. The IO operation is received from a device driver by a user-level IO function, where the IO operation has one or more guest virtual addresses. An IO memory management unit (IOMMU) validates the one or more guest virtual addresses as being associated with the IO card. If the one or more guest virtual addresses are validated as being associated with the IO card, the IO operation is allowed to propagate to the IO card.

Further embodiments, features, and advantages of the disclosed embodiments, as well as the structure and operation of the various embodiments are described in detail below with reference to the accompanying drawings.

### BRIEF DESCRIPTION OF THE DRAWINGS/FIGURES

The accompanying drawings, which are incorporated herein and form part of the specification, illustrate the disclosed embodiments and, together with the description, further serve to explain the principles of the disclosed embodiments and to enable a person skilled in the relevant art(s) to make and use the disclosed embodiments.

FIG. 1 illustrates a computer system having a virtualized environment.

FIG. 2 illustrates a traditional IOMMU architecture in a virtualized environment.

FIG. 3 illustrates a first generation of a virtualized IOMMU architecture illustrating the processing of an IO operation.

FIG. 4 illustrates a second generation of a virtualized IOMMU architecture illustrating the processing of an IO operation, in accordance with an embodiment of the present invention.

FIG. 5 provides a flowchart depicting a method for the processing of an IO operation using a virtualized IOMMU, in accordance with an embodiment of the present invention.

The features and advantages of the disclosed embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

By way of background, terms such as virtualization and virtual are used in accordance with their meaning in the computing arts. In particular, virtualization refers to techniques used to hide the physical characteristics of an underlying resource so as to simplify the approach by which systems, applications and end-users can interact with those resources. For example, virtualization allows a single physical resource (e.g., memory) to appear as multiple logical resources. Thus, virtualization techniques permit a single computer to be able to run a number of virtual machines, with each virtual machine appearing to have its full complement of resources available to it, and without any apparent overlap of resources to other virtual machines.

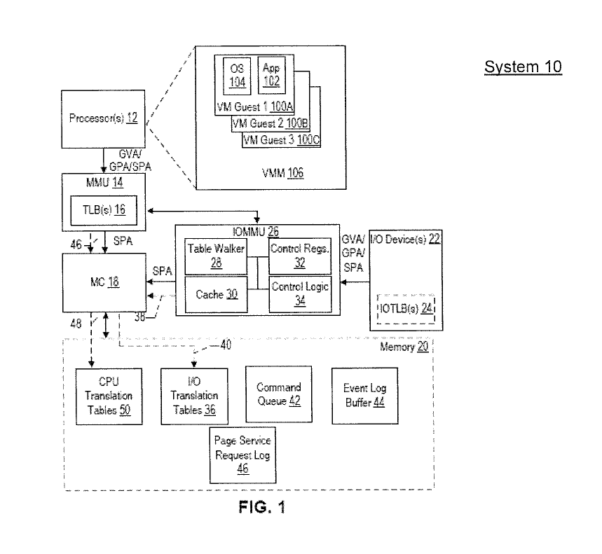

Referring to FIG. 1, a block diagram is shown that illustrates a simplified, high-level view of a computer system 10, in accordance with some embodiments. As illustrated in FIG. 1, the system 10 includes one or more processors 12, a memory management unit 14 comprising one or more translation lookaside buffers (TLBs) 16, a memory controller (MC) 18, a memory 20, one or more IO devices 22 which may comprise one or more IO TLBs (IOTLBs) 24, and an IO MMU (IOMMU) 26 which may comprise a table walker 28, a cache 30, control registers 32, and control logic 34. The processors 12 are coupled to the MMU 14, which is coupled to the memory controller 18. The IO devices 22 are coupled to the IOMMU 26, which is coupled to the memory controller 18. Within the IOMMU 26, the table walker 28, the cache 30, the control registers 32, and the control unit 34 are coupled together. FIG. 1 also illustrates a direct link between MMU 14 and IOMMU 26. Such a direct link is optional. In other embodiments, the direct link is not implemented, or the link may be accomplished via memory 20.

As described further below, the IOMMU 26 may include various features to simplify virtualization in the system 10. The description below will refer to a virtual machine monitor (VMM) that manages the virtual machines (scheduling their execution on the underlying hardware), controls access to various system resources, etc. It is noted that VMMs are also sometimes referred to as hypervisors. In the illustrated embodiment, processor(s) 12 is executing software in a virtualized environment. Accordingly, three virtual machines 100A, 100B, and 100C (e.g., VM 1-3) and a VMM 106 are shown. The number of virtual machines 100 in a given embodiment may vary, and may dynamically change during use as virtual machines are started and stopped by a user. In the illustrated embodiment, the virtual machine 100A includes one or more guest applications 102 and a guest operating system (OS) 104. The OS 104 is referred to as a “guest” OS, since the OS 104 controls the virtual machine 100 created for it by the VMM 106, rather than the physical hardware of the system 10. Similarly, the VM 100B and VM 100C may also each include one or more guest applications 102 and a guest OS 104.

Generally, the applications 102 in the virtual machines 100 use a guest virtual address space, and thus guest virtual addresses (GVA). The guest OS 104 in each virtual machine 100A, 100B, 100C may manage mappings of the GVA to guest “physical” addresses (GPA) in the virtual machine 100A, 100B, 100C. If the guest OS 104 were running directly on the system 10 hardware, with no VMM, the physical addresses generated by the guest OS 104 would indeed be the system physical addresses (SPA) of the memory locations in the system 10. However, in the virtual machine environment, the VMM 106 may manage the mappings from GPA to SPA. Thus, when processor 12 performs memory requests, the guest OS 104 may manage mappings of GVA to GPA (which may be further mapped to SPA by the VMM 106).

As illustrated in FIG. 1, the path from the IO devices 22 to the memory 20 is at least partially separate from the path of the processors 12 to the memory 20. Specifically, the path from the IO devices 22 to memory 20 does not pass through the MMU 14, but instead goes through the IOMMU 26. Accordingly, the MMU 14 may not provide memory management for the memory requests sourced from the IO devices 22. Generally, memory management may comprise address translation from one type of virtual address (i.e., an address that may be used by software) to a physical address (i.e., an address that may be used by the memory controller) and memory protection. Memory protection may control read and/or write access to the memory at some level of granularity (e.g., a page), along with various other attributes, such as privilege level requirements, cacheability and cache controls (e.g., writethrough or writeback), coherency, etc. Any set of memory protections may be implemented in various embodiments. In some embodiments, the memory protections implemented by the IOMMU 26 may differ from the memory protections implemented by the MMU 14, in at least some respects. In one embodiment, the memory protections implemented by the IOMMU 26 may be defined so that the translation tables storing the translation data used by the IOMMU 26 and the MMU 14 may be shared (although shown separately in FIG. 1 for ease of discussion). As described further below, in some embodiments that share the translation table information, when a particular page has been promoted, such as when privileges change, a table re-walk may be necessary to update translation page tables that may now be unreliable (i.e., a re-walk is needed to get new contents from CPU translation tables 50 or IO translation tables 36 into TLB 16 or IOTLB 24 or cache 30. Other embodiments may not share translation tables between the IOMMU 26 and the MMU 14, as desired.

Generally, the IO devices 22 may be configured to issue memory requests, such as memory read and write requests, to access memory locations in the memory 20 and in some cases, translation requests. The memory requests may be part of a direct memory access (DMA) read or write operation, for example. The DMA operations may be initiated by software executed by the processors 12, programming the IO devices 22 directly or indirectly to perform the DMA operations. Depending on the address space in which the software executing on the processor is running, the IO devices 22 may be provided with addresses corresponding to that address space to access the memory 20. For example, a guest application (e.g., App 102) executing on processor 12 may provide an IO device 22 with GVAs, while a guest OS executing on processor 12 (e.g., OS 104) may provide GPAs to the IO devices 22. In either case, when the IO device 22 requests a memory access, the guest addresses may be translated by the IOMMU 26 to corresponding SPAs to access the memory, and the system physical addresses may be provided to the memory controller 18 for access. That is, the IOMMU 26 may modify the memory requests sourced by the IO devices 22 to change (i.e., translate) the received address in the request to an SPA, and the memory request may be forwarded to the memory controller 18 to access the memory 20.

In various embodiments, the IOMMU 26 may provide one-level, two-level, or no translations depending on the type of address it receives from the IO device. More particularly, the IOMMU 26 may perform one-level nested translations or two-level guest translations. That is to say, the IOMMU 26 may provide both GPA to SPA translations (one-level), and GVA to SPA translations (two-level). Thus, as mentioned above, a guest application 102 may provide GVA addresses directly to an IO device 22 when requesting memory accesses, thereby making conventional VMM interception and translation unnecessary. This functionality may allow advanced computation architectures, such as compute offload, user-level IO, and accelerated IO devices, to be used more seamlessly in virtualized systems. It is noted that although one-level, two-level, or no translations are described, it is contemplated that in other embodiments, additional levels of address space may be used. In such embodiments, additional levels of translation (i.e., multilevel translations) may be performed by IOMMU 26 to accommodate the additional address spaces.

As described in greater detail below, the IOMMU 26 has a way of recognizing what type of address it is receiving in a given request. Accordingly, in embodiments in which IO devices 22 are coupled to IOMMU 26 via standard peripheral buses, such as PCI express (PCIe) interconnects, for example, a process address space identifier (PASID), may be sent to the IOMMU 26 using a transaction layer protocol (TLP) prefix.

The IOMMU 26 may use a number of data structures, such as one or more sets of IO translation tables 36 stored in the memory 20, to translate the addresses of memory and translation requests from the IO devices 22. Generally, IO translation tables 36 may be tables of translation data that can be used to translate addresses from one type to another. The IO translation tables 36 may store the translation data in any fashion. For example, in one embodiment, the IO translation tables 36 may include page tables similar to those defined in the x86 and AMD64™ instruction set architectures. Depending on the translation level, various subsets of the guest virtual address bits or guest physical address may be used to index levels of the IO translation tables 36, and each level may either be the end of translation (i.e., storing a real page number for the translation) or may point to another table (indexed by another set of address bits). The page may be the unit of translation (i.e., each address in the virtual page translates to the same physical page). Pages may have varying sizes, e.g., from 4 kilobytes up to Megabytes or even Gigabytes.

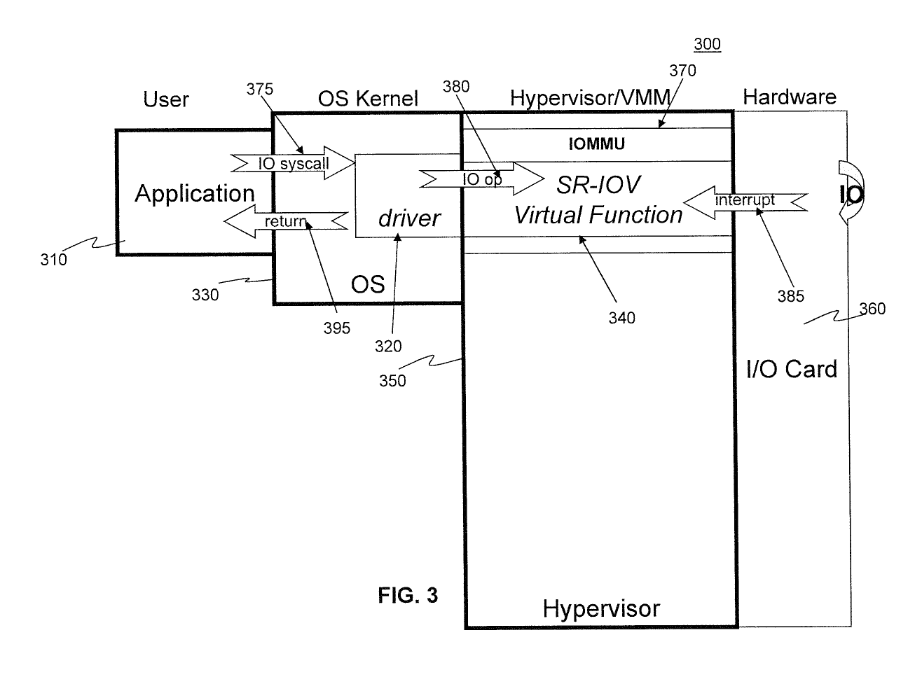

Additionally, the IO translation tables 36 may include a device table (e.g., as shown in FIG. 3) that maps IO devices to sets of page tables (e.g., by device identifiers). The device identifier (ID) may be defined in a variety of ways, and may be dependent on the peripheral interconnect to which the device is attached. For example, Peripheral Component Interconnect (PCI) devices may form a device ID from the bus number, device number and function number (BDF). HyperTransport™ (HT) devices may use a bus number and unit ID to form a device ID. As described further below, the device table may include a plurality of entries indexed by the device ID, and each entry may include a pointer to a set of page tables used by the device having the corresponding device ID. In addition, in situations where an IO device 22 is assigned directly to a process or may run computations in the same address space as a user process, the process address space is identified and provided to the IOMMU 26 to enforce memory isolation protections. In some embodiments, the device table may further include a pointer to an interrupt remapping table (e.g., as shown in FIG. 3) to remap the device's interrupts. Thus, in general, a translation from a GVA or a GPA to an SPA may be stored in one or more entries in one or more IO translation tables 36, and some of the entries may be shared with other translations. Traversing or “walking” the tables from entry to entry may be part of identifying the translation for the virtual address. In one embodiment, the IO translation tables 36 may include the interrupt remapping table mentioned above.

Specifically, the IOMMU 26 illustrated in FIG. 1 may include the table walker 28 to search the IO translation tables 36 for a translation for a given memory request. The table walker 28 may generate memory requests, e.g., read memory requests, to read the translation data from the IO translation tables 36. The translation table reads are illustrated by dotted arrows 38 and 40 in FIG. 1.

To facilitate more rapid translations, the IOMMU 26 may cache some translation data. For example, the cache 30 may be a form of cache similar to a TLB (or IOTLB), which caches the result of previous translations, mapping guest virtual and guest physical page numbers to system physical page numbers and corresponding translation data. If a translation is not found in the cache 30 for the given memory request, the table walker 28 may be invoked. In various embodiments, the table walker 28 may be implemented in hardware, or in a microcontroller or other processor and corresponding executable code (e.g., in a read-only memory (ROM) in the IOMMU 26). Additionally, other caches may be included to cache page tables, or portions thereof, and/or device tables, or portions thereof, as part of cache 30. Accordingly, the IOMMU 26 may include one or more memories to store translation data that is read from, or derived from, translation data stored in the memory 20.

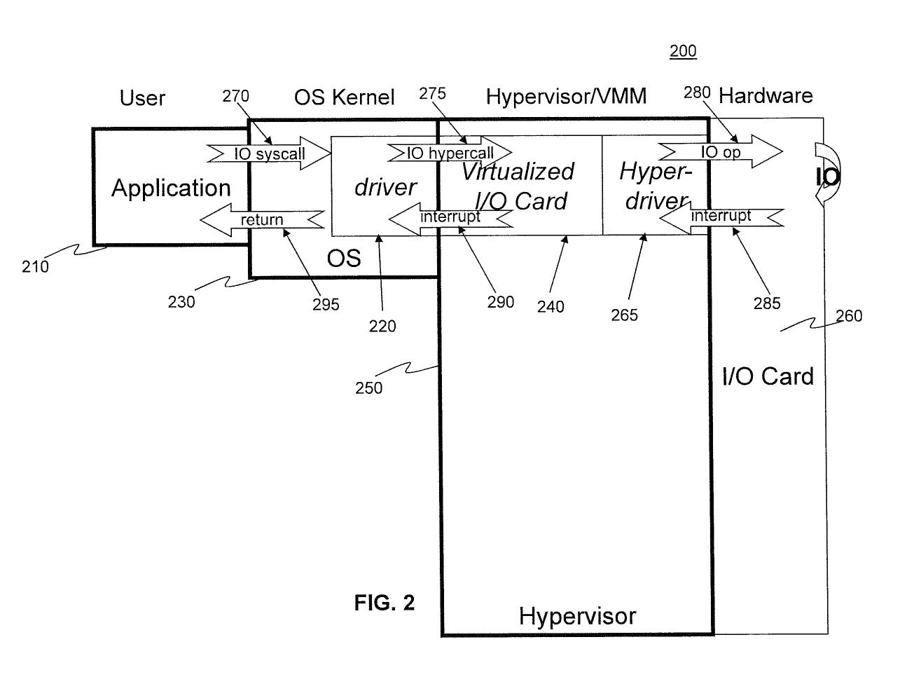

FIG. 2 illustrates a typical architecture using the traditional approach by which an application interacts with an input/output (IO) device in a virtualized environment. Referring to FIG. 2, the virtualized environment 200 includes an application 210, an operating system (or kernel) 230, a driver 220 associated with kernel 230, a virtualized IO card 240 that communicates between driver 220 and hyperdriver 265, and the IO card 260 that communicates with the external IO device (not shown). In the context of this application, the term “hyperdriver” (e.g., hyperdriver 265) is used to describe a device driver that functions in the service of a hypervisor or VMM. Driver 220 is realized in software, and operates or controls the external IO device. Hyperdriver 265 is also associated with the external IO device and is configured to run within hypervisor 250.

As noted above, when application 210 initiates an input/output (IO) operation, application 210 would call kernel 230, which would in turn call hypervisor 250. The interaction of application 210 with kernel 230 occurs via an IO system call (syscall) 270 from device driver (or driver) 220. Here, the operating system copies the relevant IO data from user space to kernel space, and dispatches the data to driver 220. Application 210 exists in the user domain, and the handoff from the user domain to the kernel domain involves the use of a context switch (not illustrated). The context switch permits kernel 230 to store the state (or context) of application 210 at the time of the IO syscall 270. Thus, the stored state permits a restore of the state at a later point in time. Consequently, kernel 230 and application 210 can continue other processes while waiting for the requested IO process to complete, and provide the requested action or information. However, the context switch is considered expensive, as it requires on the order of 5000 to 20000 instructions to execute. These instructions are considered overhead in that none of these instructions provide direct value to the calling application 210. For example, in the case of a spreadsheet application, none of these instructions directly contribute to an updated cell value in the spreadsheet file.

Continuing to refer to FIG. 2, the next step in the IO operation is that of an interaction of kernel 230 with hypervisor 250, which is done via an IO hypercall 275 from driver 220 to virtualized IO card 240. As part of this step, driver 220 copies the relevant IO data, aligns the data as necessary, and invokes virtualized IO card 240. Virtualized IO card 240 interprets the request from driver 220, and calls hyperdriver 265. Hyperdriver 265 initiates the physical IO by issuing IO operation 280 to the IO card 260. The handoff from the kernel domain to the hypervisor domain involves the use of a world switch (not illustrated). Briefly, the world switch permits the hypervisor 250 to store the state (world) of the virtual machine in which operating system 230 is running, so that a restore of the state can be achieved at a later point in time. Like the context switch, the world switch is inefficient as it incurs the overhead of a minimum of 5000 instructions times, not including the additional software overhead. Thus, the world switch is also a relatively inefficient operation in the virtualized environment.

To further accentuate the point, note that the IO syscall 270 is created by application 210 (running in the guest virtual address (GVA) space) and is sent to the kernel 230 (running in the guest physical address (GPA) space). IO syscall 270 uses processing to switch from user to kernel mode safely, and then kernel 230 validates the details of the IO request, such as the buffer addresses. Next, kernel 230 converts IO syscall 270 into a form for use by hypervisor 265, namely IO hypercall 275. Kernel 230 passes IO hypercall 275 to hypervisor 265 indirectly (e.g., via traps), but in any event, both approaches require one or more “world switches” with the associated overhead. After vetting the calling arguments and converting the addresses from GPA to system physical address (SPA) space, hypervisor 265 passes the once again reformed IO operation 280 to IO card 260. As noted, significant overheads may be incurred as IO syscall 270 and IO hypercall 275 are passed to the next level down.

In further reference to FIG. 2, at a later point in time, IO Card 260 receives the information provided by the IO device in response to the IO operation. Such information is provided through the use of a completion interrupt 285, which alerts hypervisor 250 to the availability of the IO information. The data received in completion interrupt 285 is assigned to the appropriate device hyperdriver, in this case hyperdriver 265. Hyperdriver 265 updates the state of virtualized IO card 240. Using the state stored earlier by the world switch, hypervisor 250 restores the state of kernel 230 in the virtual machine and returns an interrupt 290 to driver 220, the interrupt 290 containing information provided by the IO device in response to the IO operation. Virtualized IO card 240 is realized in software, and copies a completion report from hypervisor 250 to guest operating system, i.e., kernel 230, and posts the interrupt 290 to driver 220. In turn, the arrival of interrupt 290 alerts kernel 230 to the availability of the information from the IO device. Using the state stored earlier by the context switch, kernel 230 restores the state of application 210 associated with the original IO request. Driver 220 copies the completion report as required, and signals the completion of the IO operation to calling application 210 by initiating a return call 295. Calling application 210 then processes the completion report.

FIG. 3 illustrates a first generation of a virtualized IOMMU architecture illustrating the approach by which an application interacts with an input/output (IO) device in a virtualized environment. In this embodiment, direct IO assignment is provided, with a resulting improvement in efficiency. Referring to FIG. 3, the virtualized environment 300 includes an application 310, an operating system (or kernel) 330, a driver 320 associated with kernel 330, a SR-IOV virtual function 340 that communicates between driver 320 and an external IO card 370, that in turn communicates with the IO device (not shown). Driver 320 is realized in software, and operates or controls the external IO device. SR-IOV virtual function 340 is configured to run within hypervisor 350.

SR-IOV functionality provides a standardized approach to the sharing of IO physical devices in a virtualized environment. In particular, SR-IOV provides a mechanism by which a single root (SR) function, such as a single IO device, can appear to be multiple separate physical devices for the multiple virtual machines. For example, the IO device can be configured by hypervisor 350 to appear in the PCI configuration space as multiple functions, with each function having its own configuration space. Thus, the independent configuration space for each virtual machine enables data movement to bypass involvement of hypervisor 350.

As noted above, when application 310 initiates an input/output (IO) operation, application 310 calls kernel 330. The interaction of application 310 with kernel 330 occurs via an IO system call (syscall) 375 from device driver (or driver) 320. Here, the operating system copies the relevant IO data from user space to kernel space, and dispatches the data to driver 320. Application 310 exists in the user domain, and the handoff from the user domain to the kernel domain continues to involve a context switch (not illustrated). As noted above, the context switch permits kernel 330 to store the state (context) of application 310 at the time of the IO syscall 375. Thus, the stored state permits a restore of the state at a later point in time. Consequently, kernel 330 and application 310 can continue other processes while waiting for the requested IO process to complete, and provide the requested action or information.

Continuing to refer to FIG. 3, the next step in the IO operation is that of an interaction of kernel 330 directly with IO card 360 via a SR-IOV virtual function 340. Driver 320 copies the data associated with the requested IO process, and issues a direct IO operation 380 to the IO card 360. Absent in the architecture illustrated in FIG. 3 is the need of a world switch and its inefficient overhead. As illustrated in FIG. 3, SR-IOV virtual function 340 is “fenced” in by IOMMU 370. Here, the term “fenced” in refers to the range of valid addresses to which SR-IOV virtual function 340 can validly address. In this virtualized environment, the IOMMU 370 supports one “stage” of translation of addresses, and thus the IO card 360 (and its associated external IO device) can be assigned to guest OS (kernel) 330. SR-IOV virtual function 340 can be implemented in either software or hardware, or a hybrid of hardware and software. However, an implementation in hardware accelerates the response time of SR-IOV virtual function 340, and in addition provides increased reliability as well as a relatively bug-free implementation.

In one example, IOMMU 370 has been added to the system as part of the hardware support. Hypervisor 350 can configure IOMMU 370 to perform validation operations previously done by hypervisor software modules, with the result that IO hypercall 275 is completely eliminated. In one example, IO syscall 375 is identical in form and operation to IO syscall 270 that was illustrated in FIG. 2. In one example, IO operation 380 is substantially similar to IO hypercall 275 that was illustrated in FIG. 2. The primary change to IO operation 380 is that it now contains Guest Physical Addresses (GPA) instead of SPA. In this example, IOMMU 370 hardware does the translation and other verification previously done by software. As a result, performance is significantly improved such that the application 310 performance in a virtualized system (as illustrated) is approximately equal to performance on a nonvirtualized system (not illustrated).

As before, at a later point in time, IO card 360 receives the information provided by the IO device in response to the IO operation. Such a return is provided through the use of a completion interrupt 385, which alerts hypervisor 350 to the availability of the IO information. The data received in completion interrupt 385 is assigned to the appropriate guest OS (in this case kernel 330), and is forwarded by SR-IOV virtual function 340 to driver 320 via a virtual interrupt to the driver. In turn, kernel 330 restores the state associated with the original IO operation. Driver 320 copies the completion report as required, and signals the completion of the IO operation to calling application 310 by initiating a return call 395. Calling application 310 then processes the completion report.

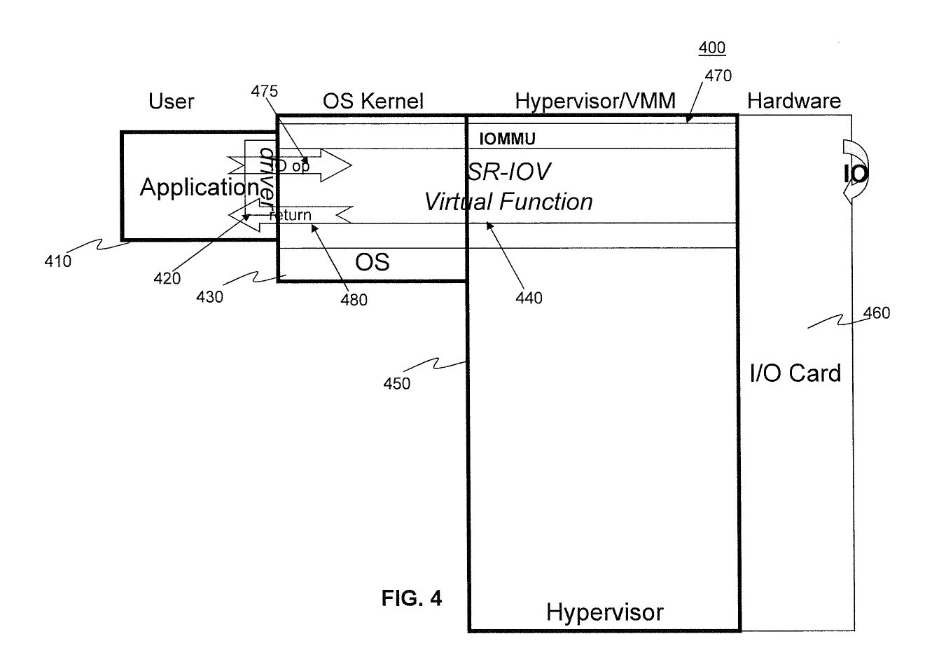

FIG. 4 illustrates a second generation of a virtualized IOMMU architecture supporting input/output (IO) device interaction in a virtualized environment, in accordance with an embodiment of the present invention. In this embodiment, user level IO is made available, with resulting efficiency improvements. Referring to FIG. 4, the virtualized IO environment 400 includes an application 410, an operating system (or kernel) 430, a driver 420 associated with kernel 430, a SR-IOV virtual function 440 that communicates between driver 420 and an external IO card 460, that in turn communicates with the IO device (not shown). Driver 420 is realized in software, and operates or controls the external IO device. SR-IOV virtual function 440 is configured to traverse from user domain across to the domain containing the hypervisor 450.

As noted above, SR-IOV functionality provides a standardized approach to the sharing of IO physical devices in a virtualized environment. In particular, SR-IOV provides a mechanism by which a single root (SR) function such as a single IO device can appear to be multiple separate physical devices for the multiple virtual machines. For example, the IO device can be configured by hypervisor 450 to appear in the PCI configuration space as multiple functions as multiple functions, with each function having its own configuration space. Thus, the independent configuration space for each virtual machine enables data movement to bypass involvement of hypervisor 450. The embodiment illustrated in FIG. 4 differs from the architecture illustrated in FIG. 2 in that the FIG. 4 embodiment is a user-level IO architecture in which independent configuration space is allocated for each user application. Such independent configuration space further enables data movement to bypass involvement of kernel 430.

With continuing reference to FIG. 4, application 410 initiates an input/output (IO) operation 475 using driver 420. Driver 420 is implanted in software in the user domain, and interacts with IO card 460 via a SR-IOV virtual function 440. Driver 420 copies the data associated with IO operation 475, and initiates the physical IO.

In this virtualized environment, the IOMMU 470 supports two “stages” of translation of addresses, and thus the IO card 460 (and its associated external IO device) can be assigned directly to application 410 within a guest OS (kernel) 430.

Thus, in this architecture, there is neither a handoff from the user domain to the kernel domain that involves a context switch, nor a handoff from the kernel domain to the hypervisor domain that involves the world switch. Accordingly, this architecture eliminates the overhead of both the context switch and the world switch and their respective inefficient overhead contributions. SR-IOV virtual function 440 is “fenced” in by IOMMU 470. As above, the term “fenced” in refers to the range of valid addresses to which SR-IOV virtual function 440 can validly address in IO operation 475. IO operation 475 contains one or more guest virtual addresses as being associated with the IO card. IOMMU 470 checks these guest virtual addresses as being within a valid range. If the guest virtual addresses are within a valid range, IO operation 475 can propagate from driver 420 to IO card 460. SR-IOV virtual function 440 can be implemented in either software or hardware, or a hybrid of hardware and software. However, an implementation in hardware accelerates the response time of SR-IOV virtual function 440, and in addition provides increased reliability as well as a relatively bug-free implementation.

In one example, because hypervisor 450 and kernel 430 can program IOMMU 470 hardware modules, application 410 can issue IO operation 475 directly to IO card 460. The previous user-kernel and kernel-hypervisor overheads are substantially eliminated because IOMMU 470 hardware modules do what the software previously did. This means that application 410 will actually run faster than a system with native hardware or a virtualized system (i.e., essentially faster than 100% performance). For example, consider a system in which application 410 is a web server and IO card 460 is a network interface card (NIC). The system illustrated in FIG. 4 may run faster than native hardware. There are similar benefits on client systems (e.g., a greater client workload accomplished for a fixed amount of power consumed, or less power consumed for a fixed workload). System integrity is maintained since application 410 and IO card 460 are limited to the application virtual address space.

As before, at a later point in time, IO card 460 receives the information provided by the IO device in response to the IO operation. Such a return is provided through an interrupt which is routed to the guest OS or kernel 430. As a result, kernel 430 posts a virtual interrupt to driver 420. The data received in the completion interrupt 485 is assigned to the appropriate guest OS (in this case kernel 430), and is forwarded by SR-IOV virtual function 440 to driver 420 via a virtual interrupt to the driver. Driver 420 copies the completion report as required, and signals the completion of the IO operation to calling application 410 by initiating a return call 480. Calling application 410 then processes the completion report.

In embodiments of the present invention, the underlying functionality is pushed down (i.e., performed) into hardware. By contrast, other approaches use the more inefficient and unreliable software approach. For example, paravirtualization attempts the same objectives as embodiments of the present invention, but paravirtualization uses software instead of hardware. In paravirtualization, programmers can modify applications and system software to provide improved efficiency, but this solution does not provide the same level of trustworthy and reliable operation that a hardware-based solution provides. An early attempt at such a software based solution was “WinSock Direct.” As known by those of ordinary skill in the art, software is vulnerable to both bugs as well as attacks by viruses. Although bugs exist in hardware, they are far less common than bugs in software, and therefore far less of a problem. Unlike software, which is readily amenable to change, hardware functionality is defined by gates and wires, and therefore cannot be modified by software attempting to subvert proper operation.

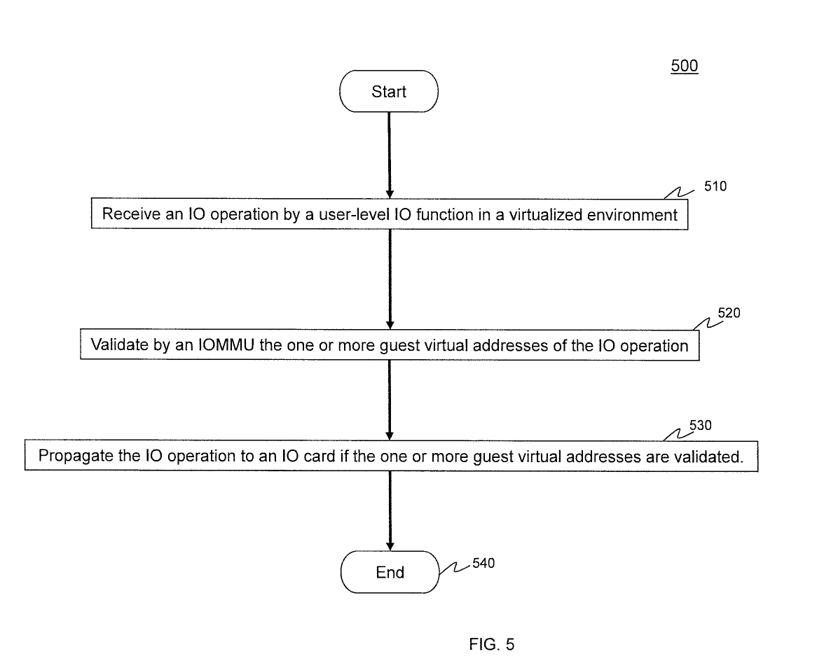

FIG. 5 provides a flowchart of a method that provides a user-level IO function in a virtualized environment, according to an embodiment of the present invention. It is to be appreciated the operations shown may be performed in a different order, and in some instance not all operations may be required. It is to be further appreciated that this method may be performed one or more processors that read and execute instructions stored on a machine-readable medium.

The process begins at step 510. In step 510, an IO operation is received by a user-level IO function in a virtualized environment. The IO operation originates in a device driver associated with an IO device, and has one or more guest virtual addresses. In an embodiment, IO operation 475 originates in driver 420.

In step 520, the one or more guest virtual addresses are validated as being associated with the IO card. Validation is performed by an IO memory management unit (IOMMU). In an embodiment, validation of the guest virtual addresses in IO operation 475 is performed by IOMMU 470.

In step 530, the IO operation is propagated to an IO card associated with the IO device if the one or more guest virtual addresses are validated as being associated with the IO card. In an embodiment, IO operation 475 is propagated to IO card 460.

In step 540, method 500 ends.

The embodiments described, and references in the specification to “some embodiments,” indicate that the embodiments described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with particular embodiments, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. For example, a virtual IOMMU may be emulated by instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the inventive subject matter such that others can, by applying knowledge within the skill of the art, readily modify and/or adapt for various applications such specific embodiments, without undue experimentation, without departing from the general concept of the inventive subject matter. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A method, comprising:
receiving, by a user-level input/output (IO) function in a virtualized environment, an IO operation from a device driver associated with an IO device, the IO operation having one or more guest virtual addresses; and
propagating the IO operation to an IO card associated with the IO device in response to the one or more guest virtual addresses being validated as being associated with the IO card,
wherein at least one of the receiving, validating and propagating are performed by one or more hardware devices.

2. The method of claim 1, further comprising:
receiving an interrupt from the IO card associated with completion of the IO operation in the IO device; and
providing a return indication to the device driver.

3. The method of claim 1, wherein the user-level IO function includes a single root input/output virtualization (SR-IOV) virtual function.

4. The method of claim 3, wherein the user-level IO function is implemented in hardware.

5. The method of claim 1, wherein the IO operation includes one of a write operation and a read operation.

6. The method of claim 1, wherein the virtual environment includes a hypervisor configured to manage one or more virtual machines.

7. The method of claim 1, further comprising:
calling the device driver by a user application.

8. The method of claim 1, further comprising:
providing, by the user-level IO function, one or more virtual devices associated with the IO device.

9. The method of claim 1, further comprising:
precluding propagation of the IO operation in response to at least one of the one or more guest virtual addresses being outside a valid range of addresses authorized for the device driver.

10. The method of claim 1, further comprising:
executing, by a virtual machine, a user application in a guest OS to thereby call the device driver.

11. An apparatus, comprising:
a user-level IO function implemented in hardware in a virtualized environment, wherein the user-level IO function is configured to propagate an IO operation from a device driver associated with an IO device to an IO card associated with the IO device, the IO operation having one or more guest virtual addresses; and
an IO memory management unit (IOMMU) function configured to validate the one or more guest virtual addresses as being associated with the IO card.

12. The apparatus of claim 11, wherein the user-level IO function is further configured to receive an interrupt from the IO card associated with completion of the IO operation in the IO device, and configured to provide a return indication to the device driver.

13. The apparatus of claim 11, wherein the user-level IO function is a single root input/output virtualization (SR-IOV) virtual function.

14. The apparatus of claim 11, wherein the user-level IO function is implemented in hardware.

15. The apparatus of claim 11, wherein the IOMMU function is further configured to validate the one or more guest virtual addresses as being within a valid range.

16. The apparatus of claim 11, wherein the virtual environment includes a hypervisor configured to manage one or more virtual machines.

17. The apparatus of claim 11, wherein the device driver is called by a user application.

18. The apparatus of claim 11, wherein the user-level IO function is further configured to provide one or more virtual devices associated with the IO device.

19. The apparatus of claim 11, wherein the IOMMU precludes the propagation of the IO operation in response to at least one of the one or more guest virtual addresses being outside a valid range of addresses authorized for the device driver.

20. The apparatus of claim 11, further comprising:
a virtual machine configured to support execution of a user application in a guest OS, the device driver being called by the user application.
